(19) United States
(12) Patent Application Publication
(10) Pub. No.: US 2025/0153952 A1
(43) Pub. Date: May 15, 2025

(54) CONVEYOR SYSTEM FOR TRANSPORTING A CONVEYED MATERIAL, METHOD FOR ADAPTING ZONES OF A CONVEYOR SYSTEM, COMPUTER PROGRAM, AND DEVICE FOR DATA PROCESSING

(71) Applicant: Murrelektronik GmbH, Oppenweiler (DE)

(72) Inventors: Olaf Prein, Lugde-Rischenau (DE); Marco Bosch, Weilheim a. d. Teck (DE)

(21) Appl. No.: 18/940,440

(22) Filed: Nov. 7, 2024

(30) Foreign Application Priority Data
Nov. 10, 2023 (DE) 10 2023 131 283.9

(51) Int. Cl. B65G 43/08; B65G 47/31

(52) U.S. Cl. CPC B65G 43/08; B65G 47/31; B65G 2203/0208; B65G 2203/0291; B65G 2203/041

(57) ABSTRACT

The invention relates to a conveyor system (100) for transporting a conveyed material (11-16), comprising a conveying device (20) that is designed to transport the conveyed material (11-16) along a conveyor line (30), the conveyor line (30) being divided into multiple zones (31-36).

The present invention relates to a conveyor system for transporting a conveyed material, a method for adapting zones of a conveyor system, a computer program, and a device for data processing for carrying out such a method.

In principle, conveyor systems are known from the prior art. For example, the publication DE 10 2016 124 250 A1 describes a device and a method for handling piece goods that are moved one behind the other.

The object of the present invention is to provide an improved conveyor system as well as an improved method for adapting zones of a conveyor system.

This object is achieved by the subject matter of the independent claims.

Further features and details of the invention result from the respective subclaims, the description, and the drawings. Features and details that are described in conjunction with the conveyor system according to the invention naturally also apply in conjunction with the method according to the invention, the device according to the invention, and the computer program according to the invention, and vice versa in each case, so that with regard to the disclosure, reciprocal reference always is or may be made to the individual aspects of the invention.

According to a first aspect, a conveyor system for transporting a conveyed material is provided.

The conveyor system includes a conveying device that is designed to transport the conveyed material along a conveyor line, the conveyor line being divided into multiple zones. Furthermore, the conveyor system may include at least one image capture device that is designed to capture at least one section of the conveyor line in at least one piece of image information. The conveyor system may also include an evaluation device that is designed to evaluate the captured image information and determine the conveyed material therein. Moreover, the conveyor system may include a control device that is designed to adapt the zones with regard to their size and/or number and/or speed, based on the determined conveyed material.

The conveyor system is used in particular to divide a conveyor line into multiple zones and individually adapt same.

For this purpose, the conveyor system first includes a conveying device that is designed to transport the conveyed material along a conveyor line.

A conveyed material may be an object, for example a workpiece, that is conveyed along a conveyor line. In particular, the conveyed material is conveyed within an industrial facility from a first position to at least one second position. Machining or processing steps for the conveyed material may then be carried out at the respective positions, in particular in a partially or completely automated manner.

The conveying device may include one or more conveying means for moving the conveyed material. It is understood that the conveying device may also be designed to transport, in particular simultaneously, multiple conveyed materials that are designed independently of one another and spaced apart from one another.

Furthermore, the conveying device may have one or more rollers, wheels, and/or bands that are movable, in particular rotatable, in at least one direction in order to transport the conveyed material along a conveyor line that is spanned or defined by the rollers, wheels, and/or bands. The rollers and/or wheels and/or bands are thus advantageously provided in each case as a conveying means or as part of a conveying means of the conveying device. The conveyor line may in particular be designed as a continuous conveyor line.

The conveyor line is in particular divided into multiple zones. For example, the conveyor line may have at least two, three, four, five, ten, or more zones. The zones may have a set, fixed, and/or predefined size and/or number as well as a variable, adjustable, and/or settable size and/or number. In particular, at least one conveying means may be provided for each zone.

The zones may advantageously be provided as parts of the conveyor line which may be independently activated with regard to a conveying speed of the conveyed material in this part. Furthermore, within a particular zone the conveying speed of the conveyed material may be constant, but the conveying speed may optionally be different in different zones. For example, for each zone at least one conveying means may be provided which may be activated independently of the at least one conveying means of the other zones.

In particular, all zones in a basic state may have essentially the same size. Alternatively or additionally, the size and/or speed are/is individually settable in each zone, either in steps or in a stepless manner. At least each conveying means preferably defines a single or dedicated zone.

In addition, it is possible for the conveyor system to include at least one image capture device that is designed to capture at least one section of the conveyor line in at least one piece of image information. The conveyor system may also have multiple image capture devices, each of which is designed to capture one or more sections of the conveyor line in multiple pieces of image information.

In particular, the image capture device or the image capture devices is/are designed in such a way that it/they is/are able to capture multiple, in particular all, zones in a piece of image information. Alternatively, at least one image capture device is provided for each zone.

The image capture device may be designed to capture at least one piece of image information. For this purpose, the image capture device may include one or more sensor devices, for example CMOS sensors, that are able to capture a piece of image information in one or more images, in particular a stream of images. In particular, the image capture device is designed to capture a piece of image information regularly, periodically, and/or continuously.

An evaluation device that is designed to evaluate the captured image information may also be provided. For this purpose, the evaluation device may include one or more processor devices, or at least access to same.

The evaluation device is designed in particular to execute, or prompt the execution of, one or more image detection algorithms in order to determine the conveyed material in the captured image information. For this purpose, the evaluation device may be coupled to the image capture device or the image capture devices, and may retrieve the image information therefrom or make it available. The evaluation device may also have one or more, in particular nonvolatile, memory devices in which one or more pieces of information may be stored.

The conveyor system may also include a control device that is designed to adapt at least one of the zones with regard to their size and/or number and/or speed (i.e., in particular the transport speed of the conveyed material in the zone), based on the determined conveyed material. The control device is in particular coupled to the evaluation device, from which it may make available or retrieve information with regard to the conveyed material in order to adapt or change the size of at least one zone. In the present context, “size” means in particular “length” and/or “width” and/or “extension,” in particular in the conveying direction. In particular, one or more zones may be combined to form a zone unit, and/or a zone may be divided into multiple zone units.

By use of the conveyor system, it is possible to divide a conveyor line into multiple zones and to individually adapt them. Conveying and processing of one or more conveyed materials in a particularly delay- and interference-free manner is thus made possible. In particular, by means of the approach according to the invention, fixed zones, each having a photoelectric barrier, may be dispensed with, and instead, multiple zones may be simultaneously detected and dynamically adapted by use of an image capture device.

Adaptation of the zones, and in particular the size and/or number and/or speed of the zones, may preferably take place by the control device adding one or more of the conveying means to a zone or removing same from a zone. The zone is defined, for example, such that within the zone, the conveying means are activated equally, for example at the same speed.

Moreover, it is conceivable for the evaluation device to be designed to determine a size parameter in the captured image information which is specific for a size of the conveyed material, and in particular for the extension of the conveyed material in the conveying direction, and in particular to quantify same. The control device may be designed to adapt the size of at least one zone based on the determined size parameter. For this purpose, the evaluation device may use suitable image detection algorithms, as described above, to determine one or more size parameters in the image information. The size parameter thus preferably includes an indication of one or more dimensions of the conveyed material, and in particular an extension of the conveyed material in the conveying direction, which may also be referred to as the length.

The size parameter may also include an indication of a width of the conveyed material, which extends essentially perpendicularly to the conveying direction. The size parameter may also contain an indication of the height, which extends essentially vertically from a conveying surface on which the conveyed material is transported, and/or perpendicularly to the width and length. In particular, the size parameter quantifies one or more of the above-mentioned dimensions, for example in centimeters or meters.

The control device may be designed to adapt the size and/or number and/or speed of at least one of the zones, based on this determined size parameter. In particular, the control device is designed to set or change the length and/or width of at least one of the zones, based on the size parameter. It is thus possible to individually adapt one or more zones to an actual size of a conveyed material.

Furthermore, it is possible for the control device to be designed to define the sizes of multiple zones differently in order to take into account different properties, and preferably sizes, of the conveyed material during transport. In particular, the control device is designed to take into account sizes of the conveyed material during transport in such a way that the conveyor line is divided by the zones into sections having different capacities. For example, one or more zone units form a first section, and one or more further zone units form a second section, within which a large number of conveyed materials that are different, in particular that are of different sizes, may be received and individually processed. It is thus possible to individually adapt zones or zone units to the requirements of the conveyed material.

It is also conceivable for the evaluation device to be designed to determine an edge of the conveyed material in the captured image information, it being possible to design the control device to adapt the size and/or number and/or speed of the zones, based on the determined edge. The evaluation device is in particular designed to determine one or more edges in the image information, in particular via suitable image detection algorithms as described above. The edge involves in particular one or more leading edges, i.e., a first or foremost edge in the travel direction, which in particular defines a beginning of the conveyed material. This enables particularly accurate control of the zones or the zone sizes.

Furthermore, the control device may be designed to control a speed in at least one zone, based on the evaluation. The control device may be designed to adapt the speed in at least one, in particular multiple, zones. The control device may preferably be designed to control the speed in the multiple zones differently, based on the evaluation. For this purpose, the control device is designed in particular to adapt a movement speed and/or conveying speed of the conveying means. The control device carries this out based, for example, on the evaluation of the determined conveyed material and in particular the determined size parameter(s) and/or the edge or edges in order to control the speed. It is thus possible to control a material flow in a particularly accurate manner. The speed in a zone is in particular the speed at which the conveyed material is transported in this zone, and/or at which the conveying means is operated in this zone.

In addition, the control device is advantageously designed to control, in particular differently, a direction in at least one of the zones and preferably in the multiple zones, based on the evaluation. In particular, the control device is designed to adapt a movement direction and/or conveying direction of the conveying means. The control device may be designed to adapt the direction in at least one, in particular multiple, zones. The control device carries this out based, for example, on the evaluation of the determined conveyed material, and in particular the determined size parameter(s) and/or the edge or edges, in order to control the direction. It is thus possible to control a material flow in a particularly accurate manner.

It is also possible for the control device to be designed to control at least two zones and/or the multiple zones independently of one another in each case. In particular, the control device is designed to individually set multiple, in particular all, zones with regard to a speed and/or direction of the transport in the zones and/or the spacings between the conveyed materials. In particular, each zone may have its own control unit or be associated with same, which controls the conveying means and is activated by the control device. Particularly exact and individual control is made possible in this way.

It is possible for the conveying device to be designed as a conveyor belt in order to transport the conveyed material in the form of packets. In particular, the conveying device is designed as a conveyor belt comprising multiple conveyor belt units which directly adjoin one another and which are adjustable or settable in particular with regard to their size. For this purpose, the multiple conveyor belt units may be provided with a stretchable or flexible conveyor belt section which has, for example, conveying means that are longitudinally displaceable or movable along the conveying direction and which can thus individually set the size of one or more zones. In this refinement, the conveyed material is in particular designed as a packet which typically has an essentially rectangular or cuboidal outer contour. Particularly efficient conveying of a packet may thus be made possible.

It is also possible for the image capture device to be designed as a camera, the image information being designed as a camera recording, and the section captured by the camera having multiple, preferably at least two or at least three or at least four or at least five, of the zones, which are thus simultaneously monitored by the camera for the zone adaptation. This enables particularly efficient and cost-effective detection.

According to a further aspect, a method for adapting zones of a conveyor system is provided, the conveyor system including a conveying device in which conveyed material is transported along a conveyor line and the conveyor line is divided into the zones having different sizes and/or speeds.

The method comprises the steps of capturing at least one piece of image information, wherein the at least one piece of image information results from an image capture using an image capture device, in which at least one section of the conveyor line has been captured; evaluating the captured image information to determine the conveyed material; and initiating an adaptation of the zones with regard to their size and/or number and/or speed, based on the determined conveyed material. The method is suited in particular for being carried out, or at least brought about, by a conveyor system described above.

Moreover, it is possible for the method steps to be carried out during operation of the conveying device and transport of the conveyed material through the zones, in order to dynamically adapt the zones, and preferably the size and/or number and/or speed of the zones, to the conveyed material being transported at that moment.

The subject matter of the invention further relates to a device for data processing, including means for carrying out the steps of the method according to the invention. The device according to the invention thus yields the same advantages as described in detail above with regard to a method according to the invention.

The subject matter of the invention further relates to a computer program, in particular a computer program product, including commands which, when the computer program is executed by a computer, prompt the computer to carry out the method according to the invention. The computer program according to the invention thus yields the same advantages as described in detail above with regard to a method according to the invention.

A data processing device, for example the device according to the invention, which executes the computer program may be provided as the computer. The computer may include at least one processor for executing the computer program. In addition, a nonvolatile data memory may be provided in which the computer program is stored, and from which the computer program may be read out by the processor for the execution.

It is also conceivable for the computer to include at least one integrated circuit, such as a microprocessor or an application-specific integrated circuit (ASIC) or an application-specific standard product (ASSP) or a digital signal processor (DSP) or a field programmable gate array (FPGA) or the like. The computer may also include at least one interface for data exchange, for example an Ethernet interface or an interface for Local Area Network (LAN) or Wireless Local Area Network (WLAN) or system on chip (SoC) or some other wireless interface such as Bluetooth or near field communication (NFC). In addition, the computer may be designed as one or more control devices, i.e., also as a system made up of control devices. The computer may also be provided, for example, in a cloud and/or as a server in order to provide the data processing for a local application via the interface. It is also possible for the computer to be designed as a mobile device, such as a smart phone.

The subject matter of the invention further relates to a computer-readable memory medium which includes the computer program according to the invention. The memory medium is designed, for example, as a data memory such as a hard disk and/or a nonvolatile memory and/or a memory card. The memory medium may, for example, be integrated into the computer. Furthermore, the method according to the invention may also be designed as a computer-implemented method.

The invention further encompasses the combinations of the features of the described embodiments. The invention thus also encompasses implementations, each of which has a combination of the features of several of the described embodiments, provided that the embodiments have not been described as mutually exclusive.

Exemplary embodiments of the invention are described below. In the figures:

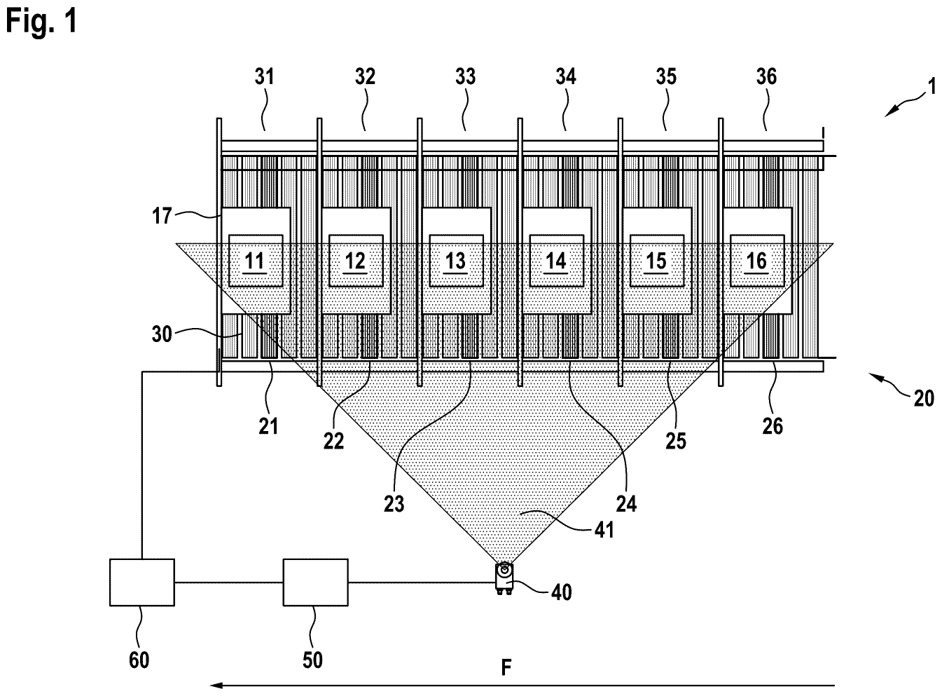

FIG. 1 shows a top view of one embodiment of a conveyor system for transporting a conveyed material in a first state;

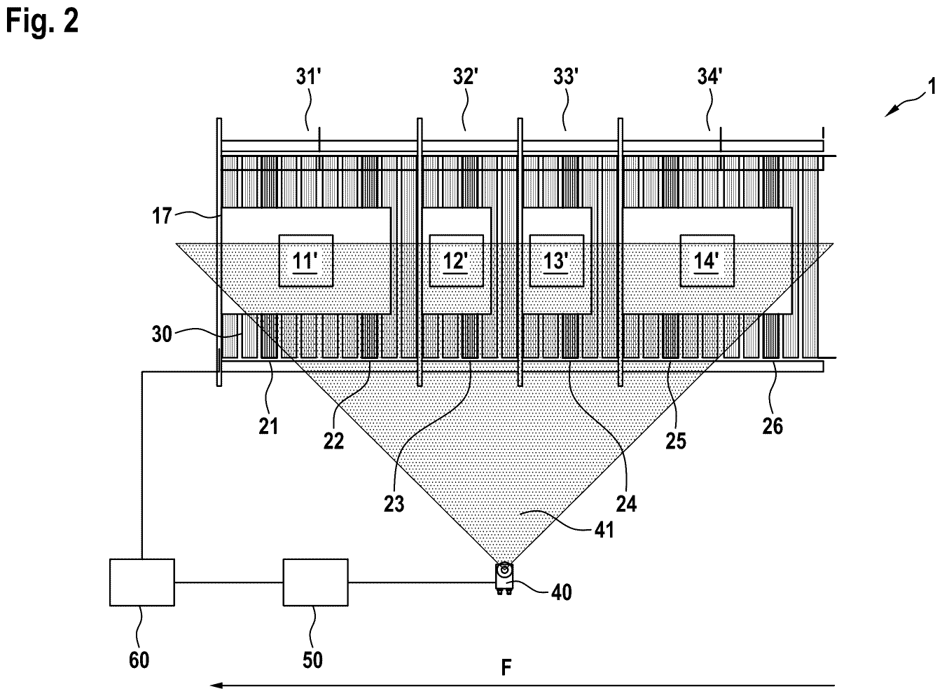

FIG. 2 shows a top view of the conveyor system from FIG. 1 in a second state; and

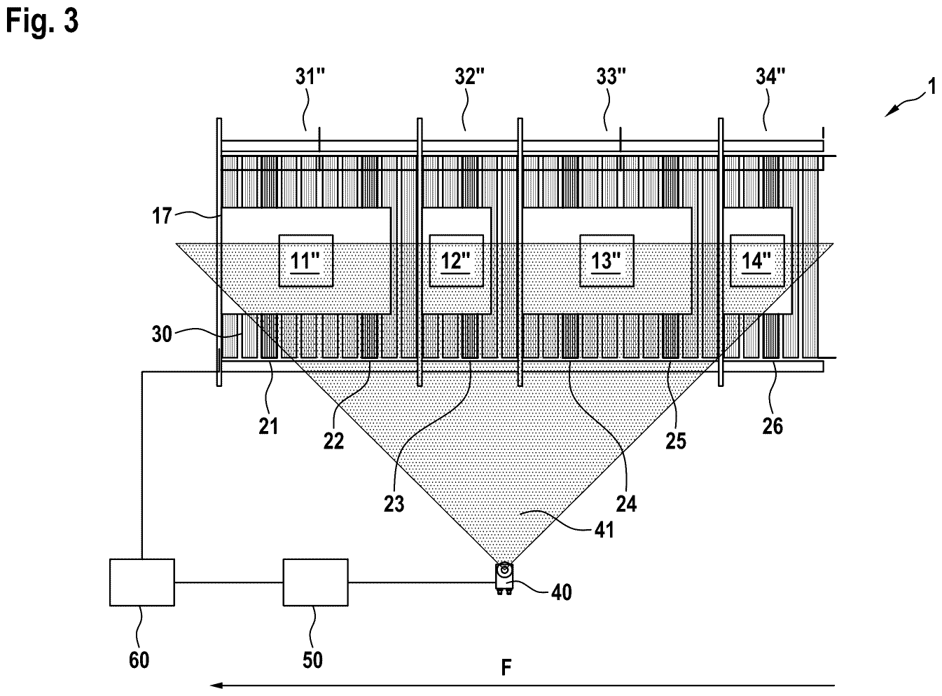

FIG. 3 shows a top view of the conveyor system from FIG. 1 in a third state.

In the figures, identical or similar features are denoted by the same reference numerals.

FIG. 1 shows a top view of one embodiment of a conveyor system 1 for transporting a conveyed material in a first state. In FIG. 1, the transported conveyed material is depicted by six conveyed materials 11 through 16 by way of example.

The conveyor system 1 includes a conveying device 20 that comprises multiple conveyor units 21 through 26 and that is designed to transport the conveyed material 11 through 16 along a conveyor line 30.

The conveyor line 30 may be divided into multiple zones 31 through 36, which in FIG. 1 are depicted by way of example as equally sized or evenly distributed zones.

The conveyor system 1 also includes an image capture device 40 that is designed to capture at least one section 41 of the conveyor line 30 in at least one piece of image information.

The conveyor system 1 also includes an evaluation device 50 that is designed to evaluate the captured image information and to determine the particular conveyed material 11 through 16 therein.

The conveyor system 1 also includes a control device 60 that is designed to adapt the zones 31 through 36 with regard to their size, based on the particular determined conveyed material 11 through 16.

The evaluation device 50 is designed to determine a size parameter in the captured image information, which is specific for a size of the particular conveyed material 11 through 16, in particular for the extension of the particular conveyed material 11 through 16 in the conveying direction F, and which in particular quantifies same. The control device 60 may be designed to adapt the size of the zones 31 through 36 based on the determined size parameter.

The control device 60 is further designed to define the sizes of the zones 31 through 36 differently in order to take into account different properties and preferably sizes of the particular conveyed material 11 through 16 during transport, so that the conveyor line 30 is preferably divided by the zones 31 through 36 into sections having different capacities, in particular as explained below in conjunction with FIGS. 2 and 3.

The evaluation device 50 may also be designed to determine an edge 17 of the conveyed material 11 in the captured image information, wherein only one edge 17 of the first conveyed material is provided with a reference numeral as an example. In this case, the control device 60 is designed to adapt the size of the zones 31 through 36 based on the determined edge 17.

The control device 60 may also be designed to control a speed and/or a direction in the zones 31 through 36 differently, based on the evaluation.

The control device 60 may also be designed to control each of the zones 31 through 36 independently of one another, in particular with regard to a different speed and/or direction of transport in the zones 31 through 36 and/or the spacings between the conveyed materials, wherein for this purpose each zone 31-36 preferably has its own control unit (not shown here for reasons of clarity) and is activated by the control device 60.

In the present case, the conveying device is shown with multiple rollers by way of example. However, the conveying device may also be designed as a conveyor belt for transporting the conveyed material, in particular in the form of packets as shown here.

The image capture device 40 may be designed as a camera, the image information being designed as a camera recording, and the section captured by the camera having multiple, preferably at least two or at least three or at least four or at least five, of the zones 31 through 36, which are thus simultaneously monitored by the camera for the zone adaptation.

According to a method for adapting zones of the conveyor system 1, initially at least one piece of image information is captured, wherein the at least one piece of image information results from an image capture using an image capture device 40, in which at least one section 41 of the conveyor line 30 has been captured. The captured image information is then evaluated to determine the conveyed material 11 through 16, and an adaptation of the zones 31 through 36 with regard to their size is then initiated, based on the determined conveyed materials 11 through 16.

The method steps are carried out during operation of the conveying device 20 and transport of the conveyed material 11 through 16 through the zones 31 through 36, in order to dynamically adapt the zones 31 through 36, and preferably the size of the zones 31 through 36, to the conveyed material 11 through 16 being transported at that moment.

FIG. 2 shows a top view of the conveyor system from FIG. 1 in a second state. Unlike the state shown in FIG. 1, the conveyed materials do not have the same size, and consequently the zones are not evenly distributed. In particular, shown first is a larger first conveyed material 11′, followed by two smaller conveyed materials 12′ and 13′, and likewise followed by a larger conveyed material 14′. Due to the different sizes of the conveyed material, the zones 31′, 32′, 33′, 34′ are also provided in different sizes. The adaptation of the number and/or size of the zones 31′, 32′, 33′, 34′ may take place dynamically during ongoing operation of the conveyor system 1. In other words, the number and/or the size of the zones 31′, 32′, 33′, and 34′ have/has been dynamically adapted to the size of the conveyed materials 11′, 12′, 13′, 14′.

As is apparent here, the conveyor units 21 and 22 form a first zone 31′, the conveyor unit 23 forms a second zone 32′, the conveyor unit 24 forms a third zone 33′, and the conveyor units 25 and 26 form a fourth zone 34′.

FIG. 3 shows a top view of the conveyor system from FIG. 1 in a third state. The same as for the state shown in FIG. 2, the conveyed materials do not have the same size and the zones are not evenly distributed, but they are depicted differently than in FIG. 2. In particular, a larger first conveyed material 11″ is shown first, followed by a smaller conveyed material 12″, followed by a larger conveyed material 13″, likewise followed by a smaller conveyed material 14″. The number and the size of the zones 31″, 32″, 33″, and 34″ have been dynamically adapted to the size of the conveyed materials 11″, 12″, 13″, 14″.

As is apparent here, the conveyor units 21 and 22 form a first zone 31″, the conveyor unit 23 forms a second zone 32″, the conveyor units 24 and 25 form a third zone 33″, and the conveyor unit 26 forms a fourth zone 34″. As an example, a speed of the zone 31″ may be the same as in zone 33″, but different from the zones 32″ and 34″.

As a whole, the illustrated embodiments show how a camera may be used as a sensor for dynamic zone adjustment of a conveyor system.

### LIST OF REFERENCE NUMERALS

1 conveyor system
11-16 conveyed material
11′-14′ conveyed material
11″-14″ conveyed material
20 conveying device
21-26 conveyor unit
30 conveyor line
31-36 zone
31′-34′ zone
31″-34″ zone
40 image capture device
41 section
50 evaluation device
60 control device

1. A conveyor system for transporting a conveyed material, comprising:
a conveying device that is designed to transport the conveyed material along a conveyor line, the conveyor line being divided into multiple zones,
at least one image capture device that is designed to capture at least one section of the conveyor line in at least one piece of image information,
an evaluation device that is designed to evaluate the captured image information and determine the conveyed material therein; and
a control device that is designed to adapt the zones with regard to their size, based on the determined conveyed material.

2. The conveyor system according to claim 1,
characterized in that
the evaluation device is designed to determine a size parameter in the captured image information which is specific for a size of the conveyed material, in particular for the extension of the conveyed material in the conveying direction (F), and in particular to quantify same, the control device being designed to adapt the size of the zones based on the determined size parameter.

3. The conveyor system according to claim 1,
characterized in that
the control device is designed to define the sizes of the zones differently in order to take into account different properties, and preferably sizes, of the conveyed material during transport, so that the conveyor line is preferably divided by the zones into sections having different capacities.

4. The conveyor system according to claim 1,
characterized in that
the evaluation device is designed to determine an edge of the conveyed material in the captured image information,
wherein the control device is designed to adapt the size of the zones based on the determined edge.

5. The conveyor system according to claim 1,
characterized in that
the control device is designed to control a speed in the zones differently based on the evaluation.

6. The conveyor system according to claim 1,
characterized in that
the control device is designed to control a direction in the zones differently based on the evaluation.

7. The conveyor system according to claim 1,
characterized in that
the control device is designed to control the zones independently of one another in each case, in particular with regard to a different speed and/or direction of the transport in the zones and/or the spacings between the conveyed materials, wherein for this purpose, each zone preferably has its own control unit that is activated by the control device.

8. The conveyor system according to claim 1,
characterized in that
the conveying device is designed as a conveyor belt in order to transport the conveyed material in the form of packets.

9. The conveyor system according to claim 1,
characterized in that
the image capture device is designed as a camera, the image information being designed as a camera recording, and the section captured by the camera having multiple, preferably at least two or at least three or at least four or at least five, of the zones, which are thus simultaneously monitored by the camera for the zone adaptation.

10. A method for adapting zones in which conveyed material is transported along a conveyor line and the conveyor line is divided into zones having different sizes, comprising:
capturing at least one piece of image information, wherein the at least one piece of image information results from an image capture using an image capture device, in which at least one section of the conveyor line has been captured,
evaluating the captured image information to determine the conveyed material,
initiating an adaptation of the zones with regard to their size, based on the determined conveyed material.

11. The method according to claim 10,
characterized in that
the method steps are carried out during operation of the conveying device and transport of the conveyed material through the zones, in order to dynamically adapt the zones, and preferably the size of the zones, to the conveyed material being transported at that moment.

12. A device for data processing comprising:
a processor; and
a memory communicatively coupled to the processor and storing a computer program comprising commands, that when executed by the processor, cause the processor to:
capture at least one piece of image information, wherein the at least one piece of image information results from an image capture using an image capture device, in which at least one section of the conveyor line has
evaluate the captured image information to determine the conveyed material, and
initiate an adaptation of the zones with regard to their size, based on the determined conveyed material.

13. A tangible, non-transitory computer-readable medium storing a computer program comprising commands, which, when the computer program is executed by a computer, prompt the computer to:
capture at least one piece of image information, wherein the at least one piece of image information results from an image capture using an image capture device, in which at least one section of the conveyor line has been captured,
evaluate the captured image information to determine the conveyed material; and
initiate an adaptation of the zones with regard to their size, based on the determined conveyed material.
